(19) United States
(12) Patent Application Publication
(10) Pub. No.: US 2018/0239514 A1
(43) Pub. Date: Aug. 23, 2018

(54) INTERACTIVE 3D MAP WITH VIBRANT STREET VIEW

(71) Applicant: Nitin Vats, Meerut (IN)

(72) Inventor: Nitin Vats, Meerut (IN)

(73) Assignee: Nitin Vats, Meerut (IN)

(21) Appl. No.: 15/752,596

(22) PCT Filed: Aug. 14, 2015
(86) PCT No.: PCT/IN2015/000325

§ 371 Date: Feb. 14, 2018

(51) Int. Cl. G06F 3/0481; G06T 17/05; G06T 19/00; G06T 13/40; G06T 15/50

(52) U.S. Cl. CPC G06F 3/04815; G06T 17/05; G06T 2200/24; G06T 13/40; G06T 15/50; G06T 19/003

(57) ABSTRACT

A method for providing interaction with a virtual object in a virtual space, the method includes providing a panoramic video of the virtual space, wherein one or more portion/s of one or more frames of the panoramic video are clickable, receiving an user input over at least one of the portions of at least one of the frames of the panoramic video, and loading a video or a 3 dimensional model of the virtual object which is predefined for the particular portion of the frame/s for which the user input is received.

### FIELD OF THE INVENTION

The invention relates to viewing of the geographical maps. More particularly, the invention relates to viewing of the street and establishments realistically with realistic interaction with objects & persons inside establishment

### BACKGROUND OF THE INVENTION

In current scenario, searching a geographical location on map is limited to graphical representation of map. However, familiarity to the location on the map is limited to these graphical representations, which is substantially different from the reality.

Existing technology of maps which includes U.S. Pat. No. 7,158,878 B2, U.S. Pat. No. 7,379,811 B2, U.S. Pat. No. 7,746,343 B1, U.S. Pat. No. 6,618,053 B1, U.S. Pat. No. 6,496,189 B1 shows location of a building on map; allow merging of map data to satellite map data; allow building schematic maps, which looks unrealistic. In some implementations, building height is also mentioned.

However, above arts do not help out to provide realistic view of the streets of the geographical location. Further, interaction with the establishments and objects placed within establishment is also substantially limited.

The object of the invention is to provide realistic street view of a geographical region, realistic view within the establishment and realistic interaction with objects within the establishment.

### SUMMARY OF THE INVENTION

The object of the invention is achieved by methods of claims 1 and 11, systems of claims 7 and 13, and a computer program product of claims 10 and 16.

According to one embodiment of the method, the method includes providing a panoramic video of the virtual space, wherein one or more portion/s of one or more frames of the panoramic video are clickable, receiving an user input over at least on of the portions of at least one of the frames of the panoramic video, and loading a video or a 3 dimensional model of the virtual object which is predefined for the particular portion of the frame/s for which the user input is received.

According another embodiment of the method, wherein the video of the virtual model is loaded such that the background appears transparent.

According yet another embodiment of the method, wherein the 3 dimensional model of the virtual model is loaded such that the background appears transparent.

According one embodiment of the method, the method includes showing real time video or virtual avatar of representative of the virtual space along with the panoramic video of the virtual space, and enabling conversation of an user with representative through video conferencing or through audio conferencing, wherein the virtual avatar of the representative is shown when the audio conferencing is used for conversation, such that the virtual avatar is shown with facial and/or body expression and appears as if representative is conversing.

According another embodiment of the method, wherein the virtual avatar is a 3 dimensional model which render in synchronization with input audio.

According another embodiment of the method, wherein virtual avatar is a 2 dimensional image whose facial expression changes using image procession in synchronization with input audio of the representative.

In one of the implementation of the invention the method includes showing a panoramic video of an street, wherein one or more virtual premises shown in one or more frames of the panoramic video are clickable, receiving an user input over at least one of the virtual premises shown in at least one of the frames of the panoramic video, and loading a video or a panoramic image the virtual premises for which the user input is received. In another implementation of the method, the method also includes receiving user input for a geo location, loading a 2 dimensional or 3 dimensional map of a virtual space around the geo location, further showing the virtual space in the map representing the desired geo location, and loading panoramic video of the street.

The display device to be used by the system can be wearable display or non-wearable display. The non-wearable display comprises electronic visual displays such as LCD, LED, Plasma, OLED, video wall, box shaped display or display made of more than one electronic visual display or projector based or combination thereof, a volumetric display to display and interaction in three physical dimensions, create 3-D imagery via the emission, scattering, beam splitter or pepper's ghost based transparent inclined display or a one or more-sided transparent display based on peeper's ghost technology. The wearable display comprises head-mounted display, optical head-mounted display which further comprises curved mirror based display or waveguide based display, head mount display for fully 3D viewing by feeding video/image/3d model of same view with two slightly different perspectives to make a complete 3D viewing of the video/image/3d model.

### BRIEF DESCRIPTION OF THE DRAWINGS

FIG. 1 (a)-(k) illustrates different schematic views of interactive 3D map according to invention

### DETAILED DESCRIPTION OF THE DRAWINGS

The present invention relates to field of 3D maps, particularly improved interactive 3D (three dimensional) map and method of generating interactive 3D map. The applications include not only for geographical location finding, enhanced and vibrant street view or guidance during travel but also and in the field of shopping, information & content industry, advertisement, travel and media industry and communication industry.

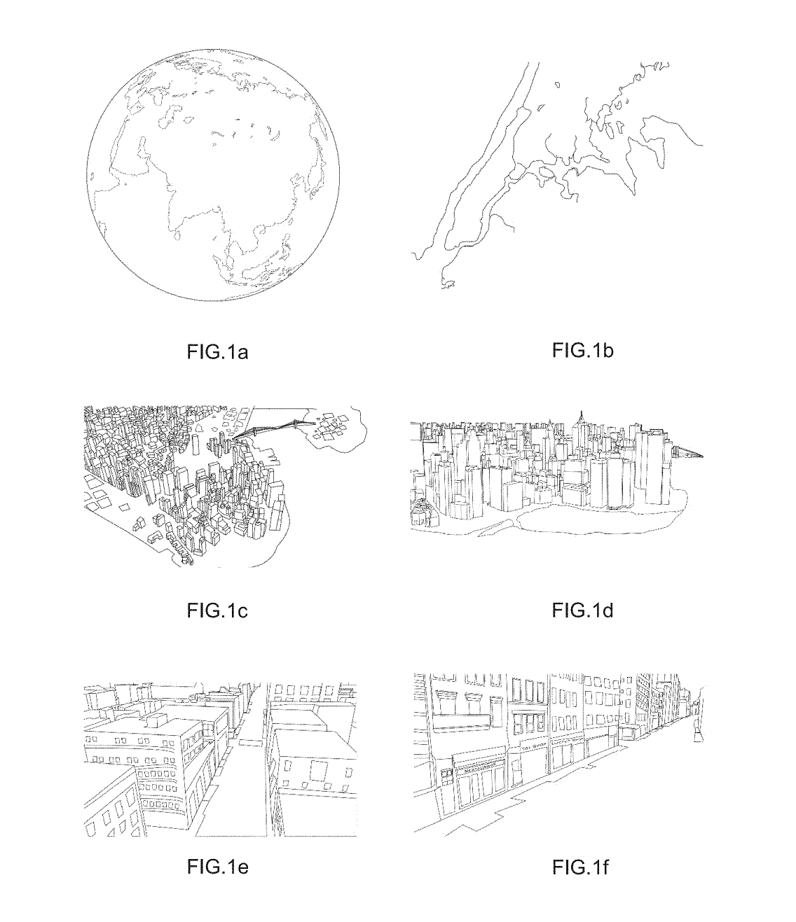

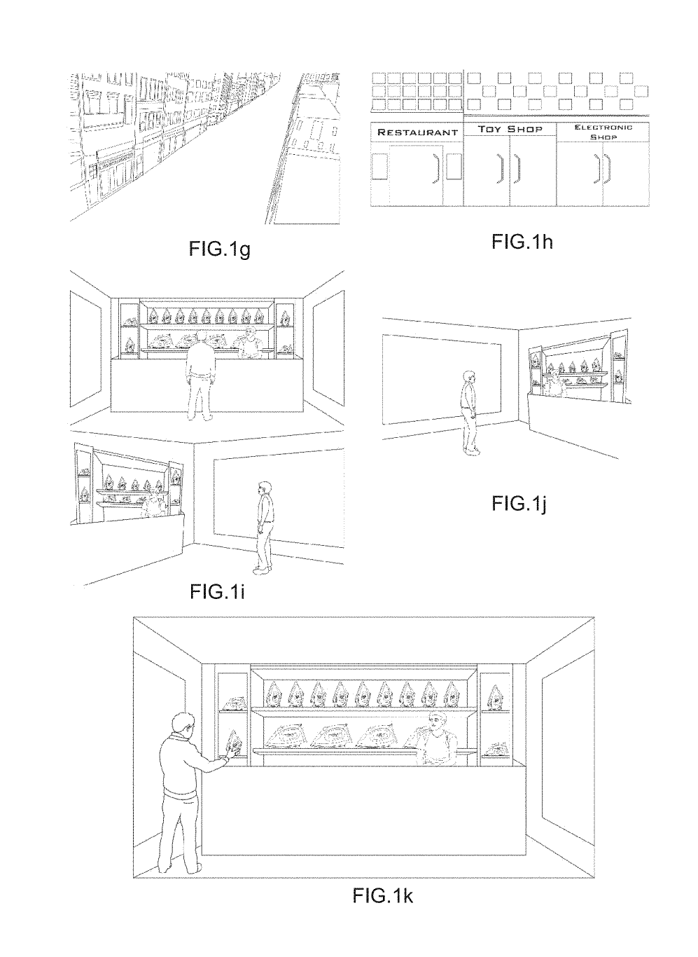

FIG. 1, through illustrations (a)-(k), shows an earth view is loaded initially in illustration (a) of FIG. 1, where the user places a search query of New Work City, and in response to the query a map of New York City is displayed as shown in illustration (b) of FIG. 1. Illustrations (c)-(f) of FIG. 1 show zooming of the New York City as per user input and desire to see a particular street. Illustration (g) of FIG. 1 shows clear street view with establishments in the said street in interactive 3D-view. The user can optionally upload his photograph, which is transformed into 3D simulation of the user or optionally use a 3D avatar, which is displayed loaded in the interactive 3D map such that the said user can see himself or herself standing in the street, emulating real life scenario when a person visits a street of a particular location. FIG. 1h shows zoomed view of shops and establishments in the said street of the New York City. The user can view simulation of a walk into any desired establishment displayed in the zoomed view as shown in illustration (i) of FIG. 1 or walk with or without using his own simulated figure or preloaded 3D avatar in the street to get a zoomed view of another set of establishments. The use of 3D avatar or uploading of self photograph is optional, and the simulation of street view and walking can be generated without using any avatars or self 3D simulated figure. In illustrations (i)-(j) of FIG. 1, the user is shown inside an electronic shop, where the electronic shop is a 3D interactive simulation of the real shop located in the said street of the New York City. The user can interact with the objects displayed in the electronic shop as shown in illustration (k) of FIG. 1 emulating real-life scenario where a user walks in a street to visit a shop to buy a product in the shop. The products in the said shop can also be shown in 3D simulation available for realistic interactions as per user desire. The user can also buy the product by placing order within the interactive 3D map set-up. The user can as per his desire walk to another destination, where the view is a continuous interactive panoramic video, capable of providing a realistic feeling emulating real life street viewing and entering the establishments the street.

The invention deals with 3D maps and its generation technology with advanced virtual reality technology. With the invention, the user will not only able to see the real object in real location such as buildings or market in 3D in the interactive and realistic 3D map, but will also be able to see through or virtually walk in the streets of the interactive 3D map in a continuous interactive panoramic video set-up. User while walking will also be able to enter an establishment and see the products in the said establishment in 3D, where the establishment and its associated information of location, products displayed within the commercial establishment are virtually same as the real establishment in real-setup. The amount of data or size of content required generating such as virtual reality picture and information will be colossal and difficult to manage with existing technology. However, such an interactive map presenting a realistic scenario according to invention is made possible with the invention.

Initially a 2D/3D map is shown. Map can be generated by using the Data and method described as follows.

Semi-Automatic building extraction from LIDAR Data and High-Resolution Images is captured for making 3D map. The method allows modelling without physically moving towards the location or object. Airborne LIDAR data, digital surface model (DSM) can be generated and then the objects higher than the ground are automatically detected from the DSM. Based on general knowledge about buildings, geometric characteristics such as size, height and shape information are then used to separate the buildings from other objects. The extracted building outlines are then simplified using an orthogonal algorithm to obtain better cartographic quality. Watershed analysis can be conducted to extract the ridgelines of building roofs. The ridgelines as well as slope information are used to classify the buildings per type. The buildings are then reconstructed using three parametric building models (flat, gabled, hipped)

Most buildings are described to sufficient details in terms of general polyhedra, i.e., their boundaries can be represented by a set of planar surfaces and straight lines. Further processing such as expressing building footprints as polygons is used for data storing in GIS databases

After the data has been collected, the acquired (and sometimes already processed) data from images or sensors needs to be reconstructed. This may be done in the same program or in some cases, the 3D data needs to be exported and imported into another program for further refining, and/or to add additional data. Such additional data could be gps-location data etc.

Panoramic Video of Street View is Constructed as Follows—

A number of techniques have been developed for capturing panoramic video of real-world scenes. One way is to record video onto a long film strip using a panoramic camera to directly capture a cylindrical panoramic video. Another way is to use a lens with a very large field of view such as a fisheye lens. Mirrored pyramids and parabolic mirrors can also be used to directly capture panoramic video.

Traditionally, A panoramic video is constructed and then viewed through a viewer which show a portion of panoramic video and can be viewed completely by panning. The panoramic image is mapped to 2D screen space by viewer.

Present invention allow user to interaction on some part of the frame of panoramic video and connect it with some other video/image or 3d model of the object.

3D-Objects can be Constructed Using Following Data and Method

3D model data includes three dimensional graphics data, texture data that includes photographs, video, interactive user controlled video, color or images, and/or audio data.

In one embodiment, a user controlled interaction unit, uses 3D model graphics data/wireframe data, texture data, audio data along with user controlled interaction support sub-system to generate the output, as per input request for interaction, using rendering engine. The methods of displaying 3 dimensional model includes steps;
generating and displaying a first view of the 3 dimensional model; —receiving an user input, the user input are one or more interaction commands comprises interactions for understanding functionality of different parts of the 3D model;
identifying one or more interaction commands;
in response to the identified command/s, rendering of corresponding interaction to 3 dimensional model of object with or without sound output using texture data, computer graphics data and selectively using sound data of the 3D-model of object; and
displaying the corresponding interaction to 3D model.

The user experience with interactive maps in brief involves: placing a search query to search a location, displaying the map of the said location by generating geographical coordinates of the location; display of continuous interactive panoramic video providing vibrant street view experience, where user can as per his desire walk in streets to desired destination; where the panoramic video is user-controlled; change the destination as per desire; virtually enter in any building in the street to watch establishments within building or walk to different building or unit in the map; further, interact with people in the said visited establishment and view things or objects placed in the visited store or establishment in realistic 3D graphic emulating real set-up.

I claim:

1. A method for providing interaction with a virtual object in a virtual space, the method comprising:
providing a panoramic video/real-time video of the virtual space, wherein one or more portion/s of one or more frames of the panoramic video are clickable;
receiving an user input over at least one of the portions of at least one of the frames of the panoramic video; and
loading an image/video or a 3 dimensional model of the virtual object which is predefined for the particular portion of the frame/s for which the user input is received.

2. The method according to the claim 1, wherein the video of the virtual object is loaded such that the background appears transparent to background.

3. The method according to the claim 1, wherein the 3dimensional model of the virtual object is loaded such that the background appears transparent to background.

4. The method according to the claim 1, wherein the 3 dimensional model of the virtual object is interactable, the method comprising:
generating and displaying a first view of the 3D model;
receiving an user input, wherein the user input are one or more interaction commands comprises interactions for understanding functionality of different parts of the 3D model;
identifying one or more interaction commands;
in response to the identified command/s, rendering of corresponding interaction to 3D model of object with or without sound output using texture data, computer graphics data and selectively using sound data of the 3D-model of object; and
displaying the corresponding interaction to 3D model, wherein the interaction can emulate the interaction with mechanical and/or electronic and/or light emitting parts similar to real object.

5. The method according to claim 1 comprising:
displaying a virtual avatar of representative of the virtual space along with the panoramic video of the virtual space; and
enabling conversation of an user with representative through video conferencing or through audio conferencing,
wherein the virtual avatar of the representative is shown when the audio conferencing is used for conversation, such that the virtual avatar is shown with facial and/or body expression and appears as if representative is conversing.

6. The method according to claim 5, wherein the virtual avatar is Artificial Intelligence based and is enabled to provide answers to the queries of user by using an Artificial Intelligence engine.

7. The method according to the claim 5, wherein the virtual avatar is a 3 dimensional model which render in synchronization with input audio.

8. The method according to the claim 5, wherein virtual avatar is a 2 dimensional image whose facial expression and/or body posture changes using image procession in synchronization with input audio of the representative.

9. A method for providing an interactive street view comprising:
showing a panoramic video of an street, wherein one or more virtual premises shown in one or more frames of the panoramic video are clickable;
receiving an user input over at least one of the virtual premises shown in at least one of the frames of the panoramic video; and
loading a video or a panoramic image the virtual premises for which the user input is received.

10. The method according to claim 9 comprising:
receiving user input for a geo location;
loading a 2 dimensional or 3 dimensional map of a virtual space around the geo location;
further showing the virtual space in the map representing the desired geo location; and
loading panoramic video of the street.

11. The method according to claim 9, wherein enabling providing interaction with a virtual object in the virtual premises, the method comprising:
providing a panoramic video/real-time video of the virtual premises, wherein one or more portion/s of one or more frames of the panoramic video are clickable;
receiving an user input over at least one of the portions of at least one of the frames of the panoramic video; and
loading an image/video or a 3 dimensional model of the virtual object which is predefined for the particular portion of the frame/s for which the user input is received.

12. The method according to the claim 11, wherein the video of the virtual object is loaded such that the background appears transparent to background.

13. The method according to the claim 11, wherein the 3 dimensional model of the virtual object is loaded such that the background appears transparent to background.

14. The method according to the claim 11, wherein the 3 dimensional model of the virtual object is interactable, the method comprising:
generating and displaying a first view of the 3D model;
receiving an user input, wherein the user input are one or more interaction commands comprises interactions for understanding functionality of different parts of the 3D model;
identifying one or more interaction commands;
in response to the identified command/s, rendering of corresponding interaction to 3D model of object with or without sound output using texture data, computer graphics data and selectively using sound data of the 3D-model of object; and
displaying the corresponding interaction to 3D model, wherein the interaction can emulate the interaction with mechanical and/or electronic and/or light emitting parts similar to real object.

15. The method according to claim 11 comprising:
displaying a virtual avatar of representative of the virtual space along with the panoramic video of the virtual space; and
enabling conversation of an user with representative through video conferencing or through audio conferencing,
wherein the virtual avatar of the representative is shown when the audio conferencing is used for conversation, such that the virtual avatar is shown with facial and/or body expression and appears as if representative is conversing.

16. The method according to claim 15, wherein the virtual avatar is Artificial Intelligence based and is enabled to provide answers to the queries of user by using an Artificial Intelligence engine.

17. The method according to the claim 15, wherein the virtual avatar is a 3 dimensional model which render in synchronization with input audio.

18. The method according to the claim 15, wherein virtual avatar is a 2 dimensional image whose facial expression and/or body posture changes using image procession in synchronization with input audio of the representative.

19. The method according to the claim 11 comprising:
loading a simulated representation of a user that is generated from photograph/s, or a 3D avatar in the street view and/or the virtual premises.

20. The method according to claim 19, wherein the simulated representation or the 3D avatar is enabled to move within the street and/or the virtual premises and further enabled to interact with the virtual premises and/or other virtual avatars present in virtual premises.
